(19) United States
(12) Patent Application Publication
(10) Pub. No.: US 2017/0255055 A1
(43) Pub. Date: Sep. 7, 2017

(54) QUANTUM DOT LIQUID CRYSTAL DISPLAY DEVICE

(71) Applicant: Shenzhen China Star Optoelectronics Technology Co. Ltd., Shenzhen City (CN)

(72) Inventor: Yuheng Liang, Shenzhen City (CN)

(21) Appl. No.: 14/908,122

(22) PCT Filed: Dec. 22, 2015
(86) PCT No.: PCT/CN2015/098339

§ 371 Date: Jan. 28, 2016

(30) Foreign Application Priority Data
Oct. 8, 2015 (CN) 201510646105.9

(51) Int. Cl. G02F 1/1335; G02F 1/1368; G02F 1/1337

(52) U.S. Cl. CPC G02F 1/133514; G02F 1/133502; G02F 1/133621; G02F 1/133617; G02F 1/133528; G02F 1/1337; G02F 1/1368; G02F 1/133512; G02F 2202/36; G02F 2001/133614; G02F 2001/133531

(57) ABSTRACT

The present invention provides a quantum dot liquid crystal display device. The quantum dot liquid crystal display device has a color filter substrate (10) that includes a first base plate (11), a quantum dot color filter (12) arranged on one side of the first base plate (11) that is adjacent to a liquid crystal layer (30), a one-way light guide film (13) arranged on one side of the first base plate (11) that is distant from the liquid crystal layer (30), and an anti-reflection transmission-enhancing film (14) arranged on the one-way light guide film (13). The one-way light guide film (13) prevents light from getting incident into the interior of the liquid crystal display device to excite quantum dots so as to overcome the issues of contrast lowering and color shifting caused by external natural light exciting the quantum dots. The anti-reflection transmission-enhancing film (14) helps overcome the issues of glare and reflection light image of the liquid crystal display panel, thereby improving comfortableness of viewing of the viewers. Thus, the quantum dot liquid crystal display device has high contrast and low surface reflectance and does not induce image doubling and eye harshness caused by glare so as to provide enhanced comfortableness of viewing.

### BACKGROUND OF THE INVENTION

1. Field of the Invention

The present invention relates to the field of display technology, and in particular to a quantum dot liquid crystal display device.

2. The Related Arts

With the continuous development of the display technology, people increasingly demand higher and higher quality of displaying. Quantum dots (QDs) are nanometer semiconductor particles in the form of spheres or similar to spheres made of elements of II-VI groups or III-V groups, having a particle size between several nanometers and tens of nanometers. Since the particle size of QDs is less than or close to the exciton Bohr radius of the corresponding material, an quantum confinement effect is generally involved, where the energy band structure is changed from quasi-continuity of the body material to the discrete structure of the quantum dot material, making the quantum dots exhibiting unique behavior of stimulated emission of light. When the size of the QDs is decreased, the energy band gap becomes increased so that the energy required for exciting the QDs and the energy released from the excited QDs returning back to the ground state are increased correspondingly, exhibiting a “blue-shifting” phenomenon of the excitation of the QDs and the fluorescent spectrum. By controlling the size of the QDs, the emission spectrum thereof may be made covering the entire range of visible light. For example, when the size of cadmium selenide is decreased from 6.6 nm to 2.0 nm, the luminescence wavelength “blue-shifts” from red light zone of 635 nm to blue light zone of 460 nm.

Quantum dot materials have advantages, such as concentrated luminescence spectrum, high color purity, and luminescence color being easily adjustable through the size, structure, or composition of the quantum dot materials. Such advantages allow for applications in display devices to effectively improve the color gamut and color restorability of the display devices. For example, patent document CN 102944943 A and other similar patent documents propose technical solutions of using quantum dot layers having a pattern structure positioned outside a display panel to replace color filters for the purposes of displaying colors. However, arranging a quantum dot layer outside a display panel would allow natural light on the outside to excite the quantum dots such that at a bright site, the contrast of the display would get lowered and color shifting may be caused. Thus, when the surrounding is bright, the external light would cause excitation that leads to lowering of contrast and even color shifting.

Patent document CN 2032041879 U proposes a one-way light guide film, which comprises ridges formed on a surface to achieve an effect of guiding light in a single direction by means of total internal reflection. Such a one-way light guide film, when positioned on an outer side of a display panel, would be good in preventing quantum dots from being excited by external light thereby improving the contrast of the display panel and eliminating color shifting. However, such a one-way light guide film increases reflection on an outside surface of a display and thus leads to certain phenomena that affect the viewing experience of the viewer including image doubling resulting from reflection of light and harshness to eyes caused by glare.

### SUMMARY OF THE INVENTION

An object of the present invention is to provide a quantum dot liquid crystal display device, which has high contrast and low surface reflectance and has no image doubling and glare, making viewers perceiving comfortable.

To achieve the above objects, the present invention provides a quantum dot liquid crystal display device, which comprises a liquid crystal display panel and a backlight module arranged under the liquid crystal display panel;

wherein the liquid crystal display panel comprises a color filter substrate and an array substrate that are opposite to each other and a liquid crystal layer arranged between the color filter substrate and the array substrate;

wherein the color filter substrate comprises a first base plate, a quantum dot color filter arranged on one side of the first base plate that is adjacent to the liquid crystal layer, a one-way light guide film arranged on one side of the first base plate that is distant from the liquid crystal layer, and an anti-reflection transmission-enhancing film arranged on the one-way light guide film; and

wherein the one-way light guide film has a light guiding direction that is consistent with a lighting direction of the backlight module.

Within a wavelength range of visible light, the anti-reflection transmission-enhancing film has a maximum reflectance that is less than 3%.

The anti-reflection transmission-enhancing film has a single-layer structure, a double-layer structure, or a multiple-layer structure having three or more layers.

The quantum dot color filter comprises therein a quantum dot material that comprises one of II-VI group quantum dot materials, III-V group quantum dot materials, I-III-VI group quantum dot materials, or multiple ones thereof.

The quantum dot material of the quantum dot color filter comprises one of CdSe, CdS, CdTe, ZnS, ZnSe, CuInS, and ZnCuInS or multiple ones thereof.

The quantum dot color filter comprises a plurality of pixel zones and each of the pixel zones comprises therein a red sub-pixel pattern, a green sub-pixel pattern, and a blue sub-pixel pattern; and the backlight module gives off blue backlighting, the red pixel pattern comprising a quantum dot material film pattern that emits red light upon excited by blue light, the green pixel pattern comprising a quantum dot material film pattern that emits green light upon excited by blue light, the blue pixel pattern comprising a transparent organic photoresist material film pattern.

The quantum dot color filter comprises a plurality of pixel zones and each of the pixel zones comprises therein a red sub-pixel pattern, a green sub-pixel pattern, and a blue sub-pixel pattern; and the backlight module gives off ultraviolet backlighting, the red pixel pattern comprising a quantum dot material film pattern that emits red light upon excited by ultraviolet light, the green pixel pattern comprising a quantum dot material film pattern that emits green light upon excited by ultraviolet light, the blue pixel pattern comprising a quantum dot material film pattern that emits blue light upon excited by ultraviolet light.

The color filter substrate further comprises an upper polarizer and an upper alignment film formed on the first base plate; and

the array substrate comprises a second base plate and a thin-film transistor (TFT) layer, a lower polarizer, and a lower alignment film formed on the second base plate.

The upper polarizer and the lower polarizer have polarization directions that are perpendicular to each other or are parallel to each other.

A black matrix is provided on the color filter substrate or the array substrate.

The present invention also provides a quantum dot liquid crystal display device, which comprises a liquid crystal display panel and a backlight module arranged under the liquid crystal display panel;

wherein the liquid crystal display panel comprises a color filter substrate and an array substrate that are opposite to each other and a liquid crystal layer arranged between the color filter substrate and the array substrate;

wherein the color filter substrate comprises a first base plate, a quantum dot color filter arranged on one side of the first base plate that is adjacent to the liquid crystal layer, a one-way light guide film arranged on one side of the first base plate that is distant from the liquid crystal layer, and an anti-reflection transmission-enhancing film arranged on the one-way light guide film;

wherein the one-way light guide film has a light guiding direction that is consistent with a lighting direction of the backlight module;

wherein within a wavelength range of visible light, the anti-reflection transmission-enhancing film has a maximum reflectance that is less than 3%;

wherein the anti-reflection transmission-enhancing film has a single-layer structure, a double-layer structure, or a multiple-layer structure having three or more layers;

wherein the quantum dot color filter comprises therein a quantum dot material that comprises one of II-VI group quantum dot materials, III-V group quantum dot materials, I-III-VI group quantum dot materials, or multiple ones thereof; and

wherein the quantum dot material of the quantum dot color filter comprises one of CdSe, CdS, CdTe, ZnS, ZnSe, CuInS, and ZnCuInS or multiple ones thereof.

The efficacy of the present invention is that the present invention provides a quantum dot liquid crystal display device, which comprises a color filter substrate that comprises a one-way light guide film and an anti-reflection transmission-enhancing film formed on a first base plate. The one-way light guide film prevents light from getting incident into the interior of the liquid crystal display device to excite quantum dots so as to overcome the issues of contrast lowering and color shifting caused by external natural light exciting the quantum dots. Further, the anti-reflection transmission-enhancing film helps overcome the issues of glare and image doubling caused by the high reflectance of the surface of the one-way transmitting layer thereby improving comfortableness of viewing of the viewers. Thus, the quantum dot liquid crystal display device of the present invention has high contrast and low surface reflectance and does not induce image doubling and eye harshness caused by glare so as to provide enhanced comfortableness of viewing.

For better understanding of the features and technical contents of the present invention, reference will be made to the following detailed description of the present invention and the attached drawings. However, the drawings are provided for the purposes of reference and illustration and are not intended to impose limitations to the present invention.

### BRIEF DESCRIPTION OF THE DRAWINGS

The technical solution, as well as other beneficial advantages, of the present invention will become apparent from the following detailed description of an embodiment of the present invention, with reference to the attached drawings.

In the drawings:

FIG. 1 is a cross-sectional view illustrating the structure of a first embodiment of a quantum dot liquid crystal display device according to the present invention; and

FIG. 2 is a cross-sectional view illustrating the structure of a second embodiment of a quantum dot liquid crystal display device according to the present invention.

### DETAILED DESCRIPTION OF THE PREFERRED EMBODIMENTS

To further expound the technical solution adopted in the present invention and the advantages thereof, a detailed description is given to a preferred embodiment of the present invention and the attached drawings.

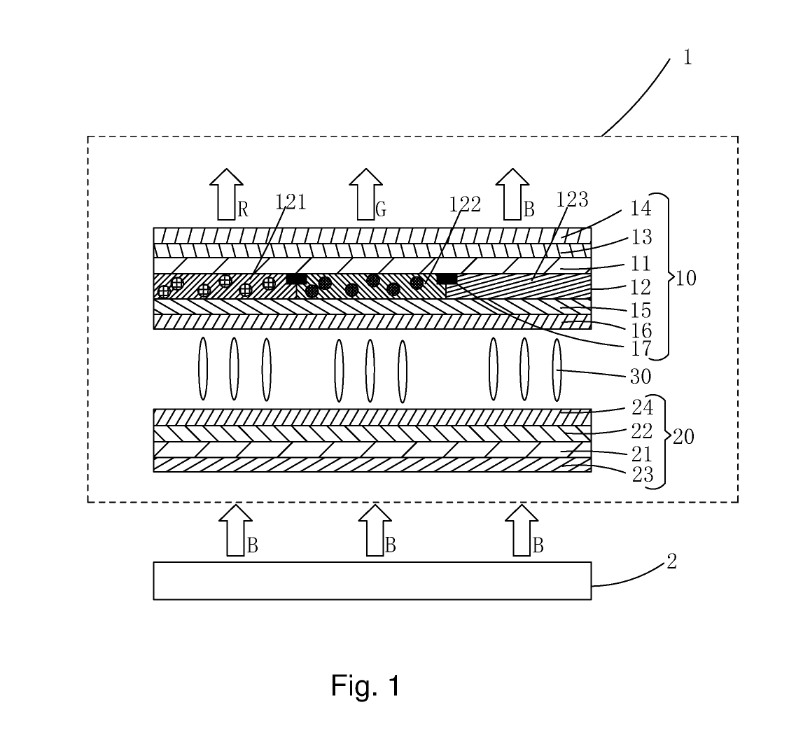

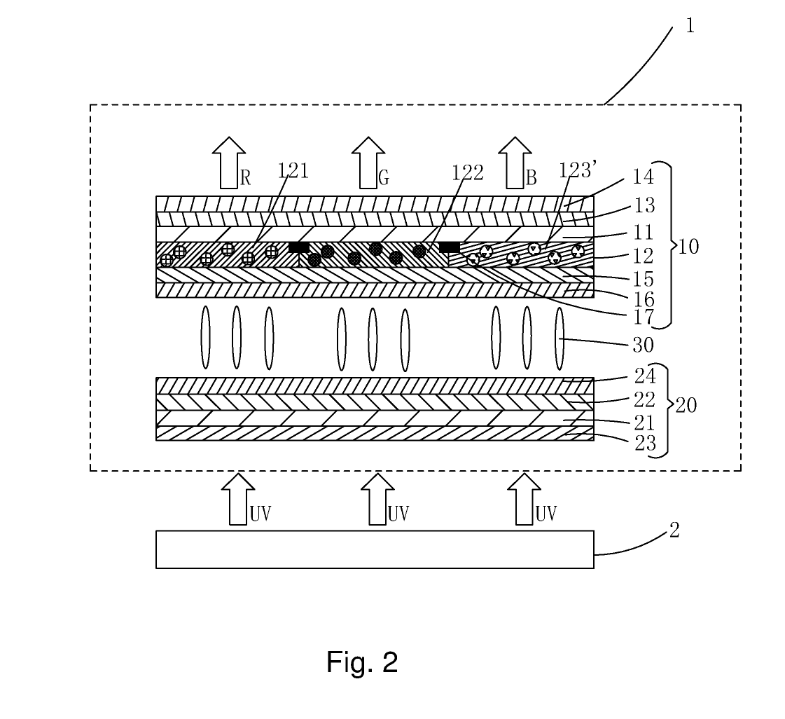

Referring to FIGS. 1-2, the present invention provides a quantum dot liquid crystal display device, which comprises a liquid crystal display panel 1 and a backlight module 2 arranged under the liquid crystal display panel 1.

The liquid crystal display panel 1 comprises a color filter substrate 10 and an array substrate 20 that are opposite to each other and a liquid crystal layer 30 arranged between the color filter substrate 10 and the array substrate 20.

The color filter substrate 10 comprises a first base plate 11, a quantum dot color filter 12 arranged on one side of the first base plate 11 that is adjacent to the liquid crystal layer 30, a one-way light guide film 13 arranged on one side of the first base plate 11 that is distant from the liquid crystal layer 30, and an anti-reflection transmission-enhancing film 14 arranged on the one-way light guide film 13.

The one-way light guide film 13 has a light guiding direction that is consistent with a lighting direction of the backlight module 2. Specifically, the one-way light guide film 13 comprises a thin membrane or glass that guides light in one single direction.

The one-way light guide film 13 allows light emitting from the interior of the liquid crystal display panel 1 to transmit through the one-way light guide film 13 to propagate outwards, while external light is blocked and reflected by the one-way light guide film 13 so as not propagate to the quantum dot color filter 12 to excite quantum dots to give off light thereby overcoming the issues of contrast lowering and color shifting caused by quantum dots being excited by external natural light. Meanwhile; the surface the one-way light guide film 13 has great reflectance, which causes issues of glare and reflection light image on a liquid crystal display device, affecting the viewing perception of viewers. In this respect, the anti-reflection transmission-enhancing film 14 arranged on the one-way light guide film 13 help well handle this issue.

Specifically, within the wavelength range of the visible light, the anti-reflection transmission-enhancing film 14 has a maximum reflectance that is less than 3%. The anti-reflection transmission-enhancing film 14 can be of a single-layer structure, a double-layer structure, or a multiple-layer structure having three or more layers. The anti-reflection transmission-enhancing film 14 comprises a coating layer, a membrane, or glass that exhibits anti-reflective property.

Specifically, the quantum dot color filter 12 comprises therein at least one of red light, green light, and blue light quantum dots. The quantum dot color filter 12 comprises therein a quantum dot material that comprises one of II-VI group quantum dot materials, III-V group quantum dot materials, group quantum dot materials, or multiple ones thereof. Preferably, the quantum dot material of the quantum dot color filter 12 comprises one of CdSe, CdS, CdTe, ZnS, ZnSe, CuInS, and ZnCuInS or multiple ones thereof.

Specifically, the color filter substrate 10 further comprises an upper polarizer 15 and an upper alignment film 16 formed on the first base plate 11. The array substrate 20 comprises a second base plate 21 and a thin-film transistor (TFT) layer 22, a lower polarizer 23, and a lower alignment film 24 formed on the second base plate 21. The upper alignment film 16 and the lower alignment film 24 are respectively arranged on opposite sides of the liquid crystal layer 30. The upper polarizer 15 is arranged between the quantum dot color filter 12 and the upper alignment film 16 and the lower polarizer 23 is arranged on one side adjacent to the backlight module 2.

Specifically, the upper polarizer 15 and the lower polarizer 23 have polarization directions that are perpendicular to each other or are parallel to each other. In the case that the polarization directions of the upper polarizer 15 and the lower polarizer 23 are perpendicular to each other, it is a normally dark mode; in the case that the polarization directions of the upper polarizer 15 and the lower polarizer 23 are parallel to each other, it is a normally bright mode.

Specifically, the color filter substrate 10 is provided with a black matrix 17, or alternatively, the array substrate 20 is provided with a black matrix, or further alternatively, the color filter substrate 10 and the array substrate 20 are both provided with a black matrix.

Referring to FIG. 1, FIG. 1 is a cross-sectional view illustrating the structure of a first embodiment of the quantum dot liquid crystal display device according to the present invention. In the instant embodiment, the quantum dot color filter 12 comprises a plurality of pixel zones, and each of the pixel zones comprises therein a red sub-pixel pattern 121, a green sub-pixel pattern 122, and a blue sub-pixel pattern 123. The backlight module gives off blue backlighting. The red pixel pattern 121 is a quantum dot material film pattern that emits red light when excited by blue light; the green pixel pattern 122 is quantum dot that emits green light when excited by blue light; and the blue pixel pattern 123 is a transparent organic photoresist material film pattern.

Referring to FIG. 2, FIG. 2 is a cross-sectional view illustrating the structure of a second embodiment of the quantum dot liquid crystal display device according to the present invention. In the instant embodiment, the quantum dot color filter 12 comprises a plurality of pixel zones, and each of the pixel zones comprises therein a red sub-pixel pattern 121, a green sub-pixel pattern 122, and a blue sub-pixel pattern 123′. The backlight module gives off ultraviolet backlighting. The red pixel pattern 121 is a quantum dot material film pattern that emits red light when excited by ultraviolet light; the green pixel pattern 122 is a quantum dot material film pattern that emits green light when excited by ultraviolet light; and the blue pixel pattern 123′ is a quantum dot material film pattern that emits blue light when excited by ultraviolet light.

In summary, the present invention provides a quantum dot liquid crystal display device, which comprises a color filter substrate that comprises a one-way light guide film and an anti-reflection transmission-enhancing film formed on a first base plate. The one-way light guide film prevents light from getting incident into the interior of the liquid crystal display device to excite quantum dots so as to overcome the issues of contrast lowering and color shifting caused by external natural light exciting the quantum dots. Further, the anti-reflection transmission-enhancing film helps overcome the issues of glare and image doubling caused by the high reflectance of the surface of the one-way transmitting layer thereby improving comfortableness of viewing of the viewers. Thus, the quantum dot liquid crystal display device of the present invention has high contrast and low surface reflectance and does not induce image doubling and eye harshness caused by glare so as to provide enhanced comfortableness of viewing.

Based on the description given above, those having ordinary skills of the art may easily contemplate various changes and modifications of the technical solution and technical ideas of the present invention and all these changes and modifications are considered within the protection scope of right for the present invention.

What is claimed is:

1. A quantum dot liquid crystal display device, comprising a liquid crystal display panel and a backlight module arranged under the liquid crystal display panel;
wherein the liquid crystal display panel comprises a color filter substrate and an array substrate that are opposite to each other and a liquid crystal layer arranged between the color filter substrate and the array substrate;
wherein the color filter substrate comprises a first base plate, a quantum dot color filter arranged on one side of the first base plate that is adjacent to the liquid crystal layer, a one-way light guide film arranged on one side of the first base plate that is distant from the liquid crystal layer, and an anti-reflection transmission-enhancing film arranged on the one-way light guide film; and
wherein the one-way light guide film has a light guiding direction that is consistent with a lighting direction of the backlight module.

2. The quantum dot liquid crystal display device as claimed in claim 1, wherein within a wavelength range of visible light, the anti-reflection transmission-enhancing film has a maximum reflectance that is less than 3%.

3. The quantum dot liquid crystal display device as claimed in claim 1, wherein the anti-reflection transmission-enhancing film has a single-layer structure, a double-layer structure, or a multiple-layer structure having three or more layers.

4. The quantum dot liquid crystal display device as claimed in claim 1, wherein the quantum dot color filter comprises therein a quantum dot material that comprises one of II-VI group quantum dot materials, III-V group quantum dot materials, group quantum dot materials, or multiple ones thereof.

5. The quantum dot liquid crystal display device as claimed in claim 4, wherein the quantum dot material of the quantum dot color filter comprises one of CdSe, CdS, CdTe, ZnS, ZnSe, CuInS, and ZnCuInS or multiple ones thereof.

6. The quantum dot liquid crystal display device as claimed in claim 1, wherein the quantum dot color filter comprises a plurality of pixel zones and each of the pixel zones comprises therein a red sub-pixel pattern, a green sub-pixel pattern, and a blue sub-pixel pattern; and the backlight module gives off blue backlighting, the red pixel pattern comprising a quantum dot material film pattern that emits red light upon excited by blue light, the green pixel pattern comprising a quantum dot material film pattern that emits green light upon excited by blue light, the blue pixel pattern comprising a transparent organic photoresist material film pattern.

7. The quantum dot liquid crystal display device as claimed in claim 1, wherein the quantum dot color filter comprises a plurality of pixel zones and each of the pixel zones comprises therein a red sub-pixel pattern, a green sub-pixel pattern, and a blue sub-pixel pattern; and the backlight module gives off ultraviolet backlighting, the red pixel pattern comprising a quantum dot material film pattern that emits red light upon excited by ultraviolet light, the green pixel pattern comprising a quantum dot material film pattern that emits green light upon excited by ultraviolet light, the blue pixel pattern comprising a quantum dot material film pattern that emits blue light upon excited by ultraviolet light.

8. The quantum dot liquid crystal display device as claimed in claim 1, wherein the color filter substrate further comprises an upper polarizer and an upper alignment film formed on the first base plate; and
the array substrate comprises a second base plate and a thin-film transistor (TFT) layer, a lower polarizer, and a lower alignment film formed on the second base plate.

9. The quantum dot liquid crystal display device as claimed in claim 8, wherein the upper polarizer and the lower polarizer have polarization directions that are perpendicular to each other or are parallel to each other.

10. The quantum dot liquid crystal display device as claimed in claim 8, wherein a black matrix is provided on the color filter substrate or the array substrate.

11. A quantum dot liquid crystal display device, comprising a liquid crystal display panel and a backlight module arranged under the liquid crystal display panel;
wherein the liquid crystal display panel comprises a color filter substrate and an array substrate that are opposite to each other and a liquid crystal layer arranged between the color filter substrate and the array substrate;
wherein the color filter substrate comprises a first base plate, a quantum dot color filter arranged on one side of the first base plate that is adjacent to the liquid crystal layer, a one-way light guide film arranged on one side of the first base plate that is distant from the liquid crystal layer, and an anti-reflection transmission-enhancing film arranged on the one-way light guide film;
wherein the one-way light guide film has a light guiding direction that is consistent with a lighting direction of the backlight module;
wherein within a wavelength range of visible light, the anti-reflection transmission-enhancing film has a maximum reflectance that is less than 3%;
wherein the anti-reflection transmission-enhancing film has a single-layer structure, a double-layer structure, or a multiple-layer structure having three or more layers;
wherein the quantum dot color filter comprises therein a quantum dot material that comprises one of II-VI group quantum dot materials, III-V group quantum dot materials, I-III-VI group quantum dot materials, or multiple ones thereof; and
wherein the quantum dot material of the quantum dot color filter comprises one of CdSe, CdS, CdTe, ZnS, ZnSe, CuInS, and ZnCuInS or multiple ones thereof.

12. The quantum dot liquid crystal display device as claimed in claim 11, wherein the quantum dot color filter comprises a plurality of pixel zones and each of the pixel zones comprises therein a red sub-pixel pattern, a green sub-pixel pattern, and a blue sub-pixel pattern; and the backlight module gives off blue backlighting, the red pixel pattern comprising a quantum dot material film pattern that emits red light upon excited by blue light, the green pixel pattern comprising a quantum dot material film pattern that emits green light upon excited by blue light, the blue pixel pattern comprising a transparent organic photoresist material film pattern.

13. The quantum dot liquid crystal display device as claimed in claim 11, wherein the quantum dot color filter comprises a plurality of pixel zones and each of the pixel zones comprises therein a red sub-pixel pattern, a green sub-pixel pattern, and a blue sub-pixel pattern; and the backlight module gives off ultraviolet backlighting, the red pixel pattern comprising a quantum dot material film pattern that emits red light upon excited by ultraviolet light, the green pixel pattern comprising a quantum dot material film pattern that emits green light upon excited by ultraviolet light, the blue pixel pattern comprising a quantum dot material film pattern that emits blue light upon excited by ultraviolet light.

14. The quantum dot liquid crystal display device as claimed in claim 11, wherein the color filter substrate further comprises an upper polarizer and an upper alignment film formed on the first base plate; and
the array substrate comprises a second base plate and a thin-film transistor (TFT) layer, a lower polarizer, and a lower alignment film formed on the second base plate.

15. The quantum dot liquid crystal display device as claimed in claim 14, wherein the upper polarizer and the lower polarizer have polarization directions that are perpendicular to each other or are parallel to each other.

16. The quantum dot liquid crystal display device as claimed in claim 14, wherein a black matrix is provided on the color filter substrate or the array substrate.
